(19) United States
(12) Patent Application Publication
(10) Pub. No.: US 2021/0396129 A1
(43) Pub. Date: Dec. 23, 2021

(54) SYSTEMS AND METHODS FOR USE WITH A SUBSEA WELL

(71) Applicant: Intelligent Wellhead Systems Inc., Calgary (CA)

(72) Inventors: Bradley Robert Martin, Calgary (CA); Aaron Mitchell Carlson, Calgary (CA); Murad Mohammad, Calgary (CA); Sheldon Kryger, Calgary (CA)

(73) Assignee: Intelligent Wellhead Systems Inc., Calgary, AB (CA)

(21) Appl. No.: 17/290,088

(22) PCT Filed: Oct. 30, 2019
(86) PCT No.: PCT/CA2019/051538

§ 371 Date: Apr. 29, 2021

Related U.S. Application Data
(60) Provisional application No. 62/752,910, filed on Oct. 30, 2018.

(51) Int. Cl. E21B 47/092; E21B 33/076

(52) U.S. Cl. CPC E21B 47/092; E21B 33/076

(57) ABSTRACT

Embodiments of the present disclosure relate to a system and method for detecting the presence, position or dimensions of a body within a portion of a subsea oil and gas well system.

### TECHNICAL FIELD

This disclosure generally relates to the drilling, completion, workover and production of hydrocarbons at a subsea oil and gas well. In particular, the disclosure relates to systems and methods for use with a subsea oil and gas well.

### BACKGROUND

Recovery of oil and gas hydrocarbons from a subsea well includes many steps. Many of these steps are staged from an offshore vessel. These steps include, but are not limited to: drilling a wellbore into the subsea floor, completing the drilled wellbore, intervening or working over the wellbore and producing hydrocarbons from the drilled wellbore up to the offshore vessel. Some of these steps can be performed by the same offshore vessel and some require a different, and often times specialized, offshore vessel.

There is a general trend of increasing the depths at which the aforementioned steps can be completed on a subsea well, which may create opportunities to recover oil and gas hydrocarbons from geological formations that previously were not feasible. As the distance between the offshore vessel on the surface and the wellhead on the subsea floor increases, so too does the uncertainty about what is happening at the subsea wellhead and between the subsea wellhead and the vessel.

### SUMMARY

Some embodiments of the present disclosure relate to a system that comprises a processor unit and at least one tool. The at least one tool is connectible to a lubricator on the offshore vessel and/or a subsea riser and/or a subsea wellhead, the at least one tool is operatively communicatable with the processor unit, wherein the at least one tool is configured to generate a magnetic field, detect a perturbation in the magnetic field that is proximal to the at least one tool and to generate a perturbation signal that is communicatable to the processor unit.

Some embodiments of the present disclosure relate to a system that comprises a processor unit and at least one tool. The at least one tool is connectible to a lubricator of a subsea wellhead, the at least one tool is operatively communicatable to the processor unit, wherein the at least one tool is configured to generate a magnetic field, detect a perturbation in the magnetic field and to generate a perturbation signal that is communicatable to the processor unit.

Some embodiments of the present disclosure relate to a method of drilling and/or intervening on a subsea wellhead. The method comprises the steps of: connecting a riser between an offshore vessel and a blowout preventer stack of the subsea wellhead; generating a magnetic field above, within or below the blowout preventer stack; detecting perturbations in the magnetic field; and communicating a perturbation signal to a processor. The perturbation in the magnetic field may be caused by a body moving into, through or away from the magnetic field and/or the perturbation in the magnetic field may be generated by a change in position and/or a change in a physical dimension of the object as it moves into, through or away from the magnetic field.

Some embodiments of the present disclosure relate to a method of intervening on a subsea well. The method comprises the steps of generating a magnetic field at a position between a subsea blowout preventer stack and a subsea lubricator connected thereto, wherein the subsea blowout preventer stack is operatively coupled to a wellhead of the subsea well; detecting perturbations in the magnetic field; and communicating a perturbation signal to a processor. The perturbation in the magnetic field is caused by a body moving into, through or away from the magnetic field and/or the magnetic field may be generated by a change in position and/or a change in a physical dimension of the object as it moves into, through or away from the magnetic field as the object moves between the blowout preventer stack and the subsea lubricator.

Without being bound by any particular theory, embodiments of the present disclosure may be useful in marine-riser based steps in recovery of oil and gas hydrocarbons from a subsea well. In particular, some embodiments of the present disclosure may allow operators to more efficiently extract tubulars and/or tools from the subsea well up to the offshore vessel by providing a signal to operators when tubulars and/or tools can be moved quickly and when they should not be moved quickly—or at all—to avoid a potential accident. Some embodiments of the present disclosure may provide a signal that allows operators to determine the location of a lost tool or portion of a tubular string. Some embodiments of the present disclosure may provide a signal that allows operators to adjust the position of the offshore vessel in order to maintain a substantially centralized position of a tubular and/or tool as it moves through a blowout preventer stack. Some embodiments of the present disclosure may provide a signal that alerts operators to a tubular that may have buckled. Some embodiments of the present disclosure may provide a signal that allows operators to determine whether or not a shearable portion of a tubular is positioned proximal or within a shear zone of a blowout preventer stack. Some embodiments of the present disclosure may relate to a system that detects one or more perturbations in a magnetic field that is positioned within a subsea environment and processing said detected perturbations and sending a display signal to a user input and display unit that is positioned on an offshore vessel.

### BRIEF DESCRIPTION OF THE DRAWINGS

These and other features of the present disclosure will become more apparent in the following detailed description in which reference is made to the appended drawings.

FIG. 1 is a side-elevation view of a known offshore oil and gas system;

FIG. 2 is a side-elevation view of an offshore oil and gas system according one embodiment of the present disclosure;

FIG. 3 is a side-elevation view of an offshore oil and gas system according to another embodiment of the present disclosure;

FIG. 4 is a side-elevation view of an offshore oil and gas system according to another embodiment of the present disclosure;

FIG. 5 is a side-elevation view of an offshore oil and gas system according to another embodiment of the present disclosure;

FIG. 6 is a side-elevation view of an offshore oil and gas system according to another embodiment of the present disclosure;

FIG. 7 is a side-elevation view of an offshore oil and gas system according to another embodiment of the present disclosure;

FIG. 8 shows a system, according to embodiments of the present disclosure, for use with an offshore oil and gas system;

FIG. 9 shows a portion of the system shown in FIG. 8 as comprising a tool, according to embodiments of the present disclosure;

FIG. 10 is a side-elevation view of the tool shown in FIG. 9A, wherein FIG. 10A shows the tool in a closed position; and FIG. 10B shows the tool in an open position;

FIG. 11 shows two embodiments of a tool according to the present disclosure, wherein FIG. 11A is a top-plan view of the tool shown in FIG. 10 taken through line 11-11¹ shown in FIG. 10; and, FIG. 11B is a top-plan view of another embodiment of a tool;

FIG. 12 shows a sensor unit for use with the tool shown in FIG. 10, wherein FIG. 12A is a front-elevation view of the sensor unit; and FIG. 12B is a cross-sectional view taken through line B-B¹ shown in FIG. 12A;

FIG. 13 shows different embodiments of a lubricator and connection members for use with the tool shown in FIG. 10, wherein FIG. 13A is a mid-line, cross-sectional side elevation view of a first embodiment that comprises clamps for providing a greater mass of magnetic material; FIG. 13B is a mid-line, cross-sectional side elevation view of a second embodiment that is configured to connect with a drill string; and FIG. 13C is a mid-line, cross-sectional side elevation view of a third embodiment that is configured to connect to a flanged pipe; and

FIG. 14 is a schematic of a method for moving a tubular away from a subsea wellhead and towards an offshore vessel.

### DETAILED DESCRIPTION

Some embodiments of the present disclosure relate to a system, a processor unit and at least one tool. The at least one tool is connectible to a lubricator on the offshore vessel and/or a subsea riser and/or a subsea wellhead, the at least one tool is operatively communicatable with the processor unit, wherein the at least one tool is configured to detect a perturbation in the magnetic field and to generate a perturbation signal that is communicatable to the processor unit.

Some embodiments of the present disclosure relate to a system that comprises a processor unit and at least one tool. The at least one tool is connectible to a lubricator of a subsea wellhead, the at least one tool is operatively communicatable to the processor unit, wherein the at least one tool is configured to detect a perturbation in a magnetic field that may be generated by the tool. The tool is further configured to generate a perturbation signal that is communicatable to the processor unit, where the perturbation signal reflects a perturbation of the magnetic field.

Some embodiments of the present disclosure relate to a system that comprises a processor unit, an interface and at least one tool. The processor unit may be positioned upon an offshore vessel or it may be positioned within a body of water upon which the offshore vessel is positioned or one tool may be positioned upon the offshore vessel and another tool may be positioned in the body of water. The interface may be operatively coupled with the processor unit by a first conduit for providing communication therebetween. The at least one tool is connectible to a lubricator on the offshore vessel and/or a subsea riser and/or a subsea wellhead. The at least one tool is operatively coupled to the interface box by a second conduit. The at least one tool is configured to detect a perturbation in a magnetic field and to generate a perturbation signal that is communicatable to the processor unit through the first conduit and the second conduit. In some embodiments of the present disclosure, the at least one tool is also configured to generate a magnetic field.

Some embodiments of the present disclosure relate to a system that comprises a processor unit, an interface and at least one tool. The processor unit may be positioned upon an offshore vessel or it may be positioned within the body of water upon which the offshore vessel is positioned. The interface may be operatively coupled with the processor unit by a first conduit for providing communication therebetween.

The at least one tool is connectible to a lubricator of a subsea wellhead and the at least one tool is operatively coupled to the interface box by a second conduit. The at least one tool is configured to detect a perturbation in the magnetic field and to generate a perturbation signal that is communicatable to the processor unit through the first conduit and the second conduit. In some embodiments of the present disclosure, the at least one tool is also configured to generate a magnetic field.

Some embodiments of the present disclosure relate to a method of drilling and/or intervening on a subsea wellhead. The method comprises the steps of: connecting a riser between an offshore vessel and a blowout preventer stack of the subsea wellhead; generating a magnetic field above, within or below the blowout preventer stack; detecting a perturbation in the magnetic field; and communicating a perturbation signal to a processor . The perturbation in the magnetic field is caused by a body moving into, through or away from the magnetic field.

Some embodiments of the present disclosure relate to a method of intervening on a subsea well. The method comprises the steps of generating a magnetic field at a position between a subsea blowout-preventer stack and a subsea lubricator connected thereto, wherein the subsea blowout-preventer stack is operatively coupled to a wellhead of the subsea well; detecting perturbations in the magnetic field; and communicating a perturbation in the magnetic field signal to a processor. The perturbation in the magnetic field is caused by a body moving into, through or away from the magnetic field as it moves between the blowout preventer stack and the subsea lubricator.

Definitions

Unless defined otherwise, all technical and scientific terms used herein have the same meaning as commonly understood by one of ordinary skill in the art to which this disclosure belongs.

As used herein, the term “about” refers to an approximately +/−10% variation from a given value. It is to be understood that such a variation is always included in any given value provided herein, whether or not it is specifically referred to.

As used herein, the terms “align”, “aligned” or “in alignment” describe an arrangement between two or more components of a system described herein, where the two or more components each have a central bore that are physically arranged to be in fluid communication with each other.

As used herein, the term “amplitude” describes the difference between the lowest value of a specific outcome that is being measured and the highest value of the same outcome.

As used herein, the term “ferromagnetic” describes the properties of a material that allow that material to be attracted to a magnet and/or be converted into a permanent magnet. For clarity, ferromagnetic materials described herein are not limited to materials that contain iron.

As used herein, the term “ferromagnetism” describes the mechanism by which materials respond to a magnetic field. For clarity, ferromagnetism includes ferrimagnetism, paramagnetism, diamagnetism and antiferromagnetism.

As used herein, the term “magnetic field” describes a field of force with a magnitude and direction that is created by moving magnetic dipoles and/or moving electric charges and that exerts force on other nearby magnetic dipoles and/or electric charges.

As used herein, the term “magnetic field strength” describes a magnitude of the magnetic field and the force it exerts on nearby magnetic dipoles or electric charges.

As used herein, the term “magnetic flux” describes a measurement of the magnitude of the total magnetic field that is passing through a unit area.

As used herein, the term “magnetic flux density” describes the amount of magnetic flux that passes through a unit area perpendicular to the magnetic field lines of the magnetic field.

As used herein, the term “magnitude” describes a detectable value of a specific outcome that is being measured at a given point in time.

As used herein, the term “target magnitude-field” is used to refer to the magnetic field that the magnetic sensor described in the present disclosure is designed to measure one or more properties of and/or changes in one or more properties in that magnetic field.

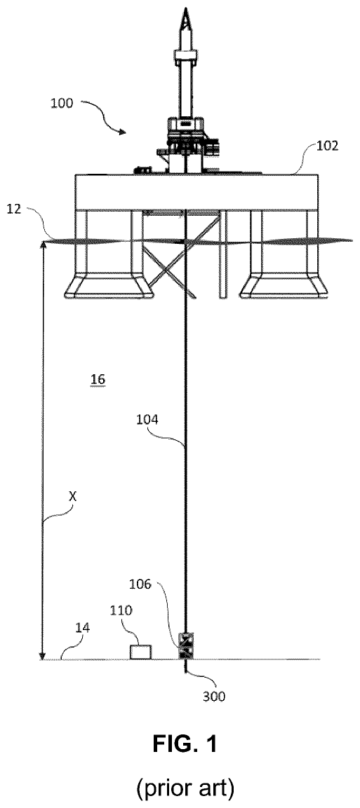

Embodiments of the present disclosure will now be described by reference to FIG. 1 to FIG. 14.

FIG. 1 shows an example of a known system for developing and producing from a subsea well 300 that provides access to oil and/or gas hydrocarbons below a subsea surface 14. The system comprises an offshore vessel 100 that is positioned upon a surface 12 of, or partially submerged within, a body of water 16. The offshore vessel 100 can be any variety of a floating vessel, a partially submerged vessel, a tethered vessel, a moored vessel, a jack-up vessel, a lift boat, a dynamically positioned vessel, or other type of suitable vessel or platform that can support the equipment required for drilling and/or completing and/or producing from the subsea well 300.

A subsea wellhead 106 can be established at the subsea surface 14 end of the subsea well 300. Depending on the operations that are occurring at a given time, the subsea wellhead 106 can include many components such as, but not limited to: a subsea Christmas tree, a subsea blowout preventer (BOP) stack and a riser connection package. These components of the subsea wellhead 106 each define a central bore and are releasably connected to in a vertical arrangement so that each central bore is aligned. The subsea BOP stack may include one or more components such as one or more of a gate valve, a ball valve, a ram BOPs, an annular style BOP, a stuffing box-type BOP, and a set of shearing BOPs. These components of the BOP stack are configured to control, either alone or in combination, pressures within sections of the subsea well 14. The subsea wellhead 106 is positioned above the surface end of the subsea well 300 so that the central bore of the subsea wellhead 106 is aligned with a central bore of the subsea well 300.

In some systems, the offshore vessel 100 can be connected to the subsea wellhead 106 by a marine riser 104 that is operatively coupled to a riser connection package of the subsea wellhead 106. The riser 104 is a string of connected tubulars, such as flanged casing or threaded pipe that defines a central bore and that extends a distance X through the body of water 16 generally between the surface 12 and the subsea surface 14. In some systems, the position of the offshore vessel 100 can be adjusted so that the central bore of the riser 104 is aligned with a central bore of the subsea wellhead 106 (and its various components) and, therefore, the central bore of the subsea well 300. The features of the riser 104 and the types of connected tubulars that are used to make up the riser 104 can depend on the types of operation(s) that the system is conducting. For example, it is common for flanged risers to be used to make up the rise while drilling the subsea well 300. It is also common for threaded pipe, such as threaded drill pipe, to be used to make up the riser 104 while performing completions, interventions or workovers on the subsea well 300. These operations can also be referred to as open-water interventions. When the riser 104 is used for performing one or more intervention operations upon the subsea well 300, a lubricator is typically positioned on a working floor 102 of the offshore vessel 100 so that tubulars and/or tools can be introduced into the central bore of the rise 104 and, ultimately, into the subsea well 300.

In some operations it may be desirable to perform interventions on the subsea well 300, but a riser 104 is not required. These types of interventions may be referred to as “riser-less interventions”. These interventions often require a subsea lubricator be operatively coupled to the top of the BOP stack of the subsea wellhead 106. Coiled tubing or a string of wireline can extend at least the distance X through the body of water 16 into the subsea lubricator and into the subsea well 300. The coiled tubing or wireline can be used with tools attached thereto, or not.

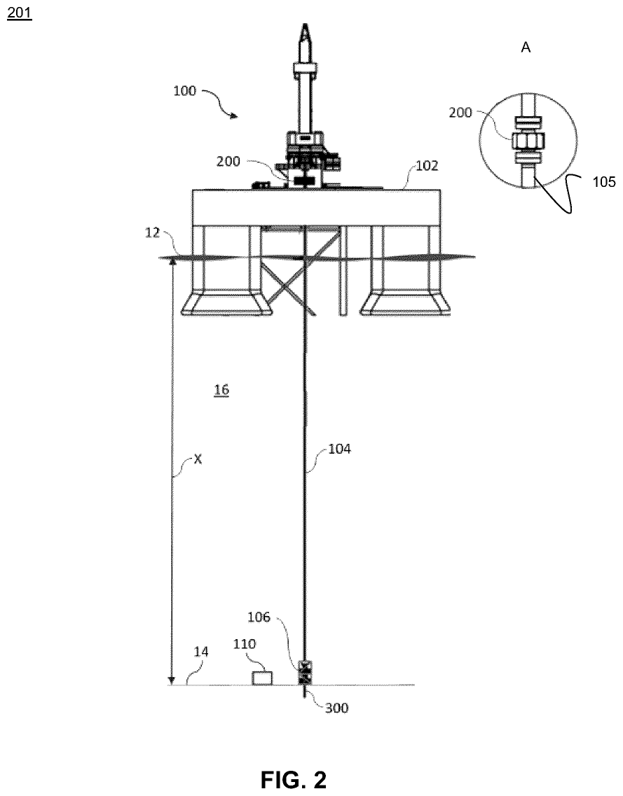

FIG. 2 shows a system 201 for developing and producing from a subsea well 300 that provides access to oil and/or gas hydrocarbons below the subsea surface 14, according to embodiments of the present disclosure. For clarity, the systems shown in FIG. 1 and FIG. 2 through 7 comprise many of the same features and, as such, the same reference numbers are used to indicate the same (or similar features) in each system shown and described herein.

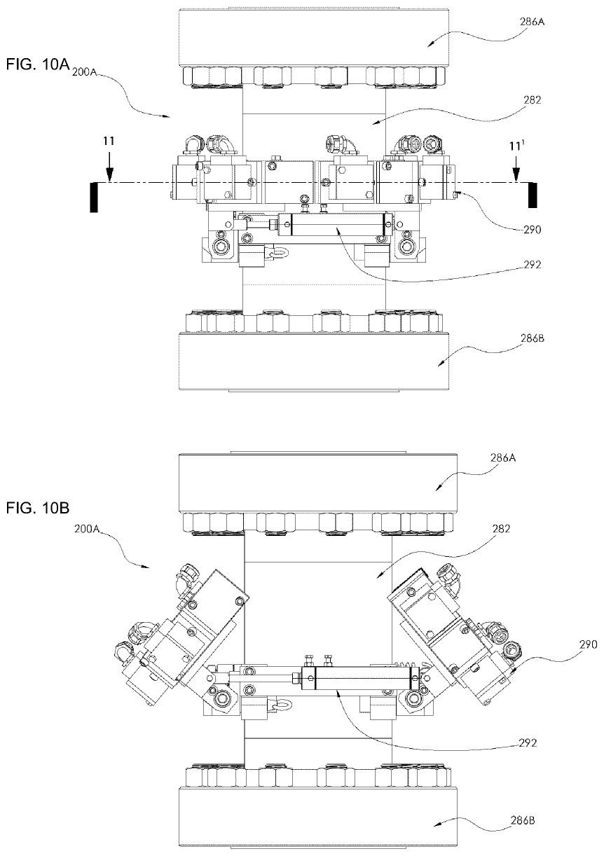

At least one difference between the system of FIG. 1 and the system 201 of FIG. 2 is that the system 201 comprises at least one tool that is operatively coupled to a lubricator 105 on a working floor 102 of the offshore vessel 100 (shown in circle A of FIG. 2). The at least one tool may also be referred to herein as a first tool 200. The first tool 200 comprises a tubular portion 282, and a tool array 292 (see FIG. 10). The tubular portion 282 defines a central bore 283 between a first and second connection member 286A, 286B at each end of the tubular portion 282. The first and second connection members 286A, 286B are connectible to be aligned with the lubricator 105 on the offshore vessel 100. As discussed further below, the tool array 292 is configured to detect perturbations in a magnetic field and to generate a perturbation signal that reflects the detected perturbation in the magnetic field.

By operatively coupling the first tool 200 to the lubricator on the offshore vessel 100, the first tool 200 can detect perturbations in a magnetic field that is generated about the offshore vessel's 100 lubricator.

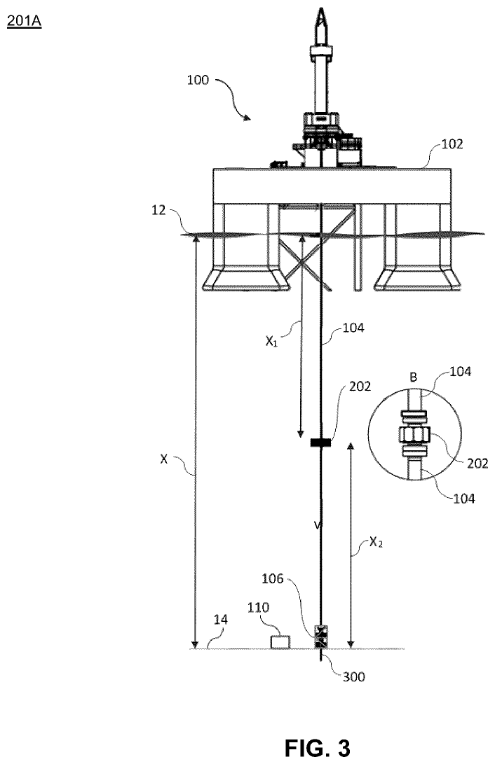

FIG. 3 shows another example of a system 201A that includes many of the same features as system 201 with at least one exception being that the at least one tool is a second tool 202 that is operatively coupled to a marine riser 104 that extends between the offshore vessel 100 and the subsea wellhead 106. Similar to the first tool 200, the second tool 202 comprises a tubular, tubular portion 282, and a tool array 292 (see FIG. 10). The tubular portion 282 defines a central bore between a first and second connection member 286A, 286B at each end of the tubular portion 282. The first and second connection members 286A, 286B are connectible to be aligned with the riser 104. As discussed further below, the tool array 292 is configured to detect perturbations in a magnetic field and to generate a perturbation signal that reflects the detected perturbation in the magnetic field.

The second tool 202 can be operatively coupled to the riser 104 at a first distance X₁ from the offshore vessel 100 and a second distance X₂ from the subsea wellhead 106. As will be appreciated by the person skilled in the art, the distance X₂ can vary depending on a number of factors. In some embodiments of the present disclosure, the distance X₁ may be between about 5% and about 25% of the total distance X towards the offshore vessel 100. In some embodiments of the present disclosure, the X₁ may be between about 10% and about 20% of the total distance X towards the offshore vessel 100.

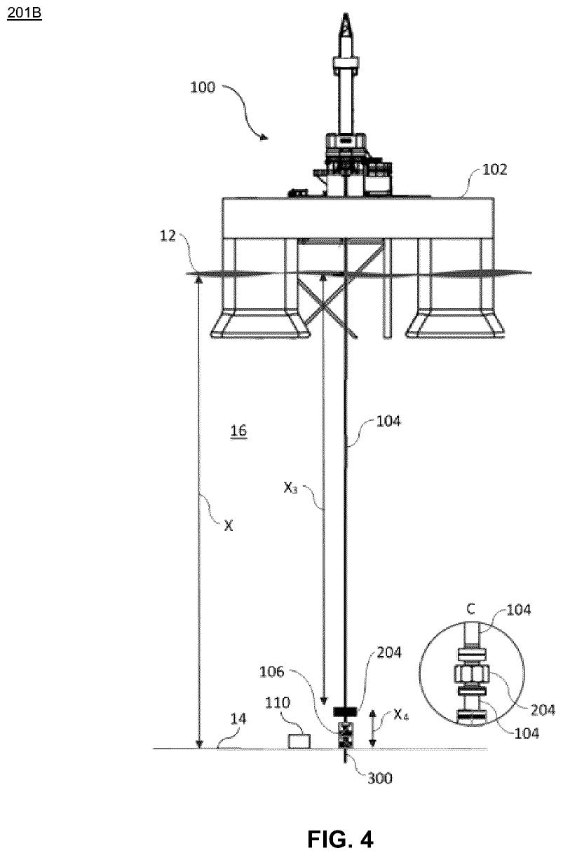

FIG. 4 shows another example of a system 201B that includes many of the same features as system 201 with at least one exception being that the at least one tool is a third tool 204 that is operatively coupled to a marine riser 104 proximal to the subsea wellhead 106. Similar to the first tool 200, the third tool 202 comprises a tubular portion 282, and a tool array 292 (see FIG. 10). The tubular portion 282 defines a central bore between a first and second connection member 286A, 286B at each end of the tubular portion 282. The first and second connection members 286A, 286B are connectible to be aligned with the riser 104. As discussed further below, the tool array 292 is configured to detect perturbations in a magnetic field and to generate a perturbation signal that reflects the detected perturbation in the magnetic field.

The third tool 204 can be operatively coupled to the riser 104 at a third distance X₃ from the offshore vessel 100 and a fourth distance X₄ from the subsea wellhead 106. As will be appreciated by the person skilled in the art, the distance X₄ can vary depending on a number of factors. In some embodiments of the present disclosure, the distance X₄ may be between about 5% and about 25% of the total distance X towards the subsea wellhead 106. In some embodiments of the present disclosure, the X₄ may be between about 10% and about 20% of the total distance X towards the subsea wellhead 106.

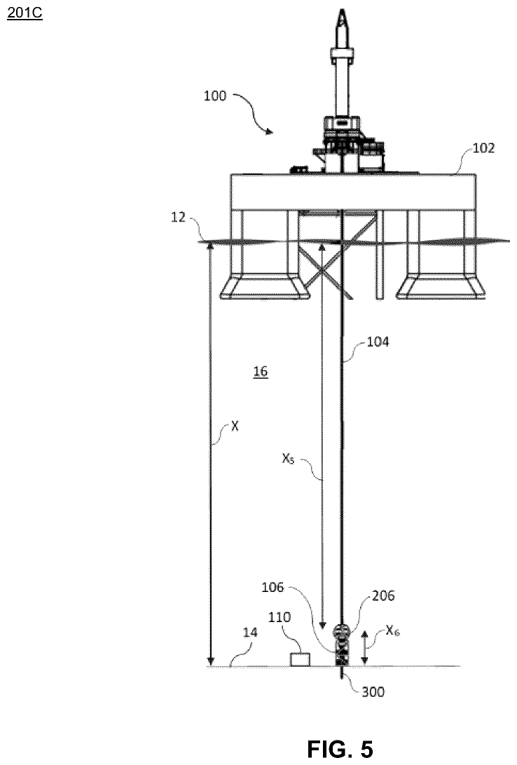

FIG. 5 shows another example of a system 201C that includes many of the same features as system 201B with at least one exception being that the at least one tool is a fourth tool 206 that is operatively coupled to the marine riser 104 and the subsea wellhead 106. Similar to the first tool 200, the third tool 202 comprises a tubular, tubular portion 282, and a tool array 292 (see FIG. 10). The tubular portion 282 defines a central bore between a first and second connection member 286A, 286B at each end of the tubular portion 282. The first and second connection members 286A, 286B are connectible to be aligned with the riser 104 and the subsea wellhead 106. As discussed further below, the tool array 292 is configured to detect perturbations in a magnetic field and to generate a perturbation signal that reflects the detected perturbation in the magnetic field.

The fourth tool 206 can be operatively coupled to the riser 104 at a fifth distance X₅ from the offshore vessel 100 and a sixth distance X₆ from the subsea wellhead 106.

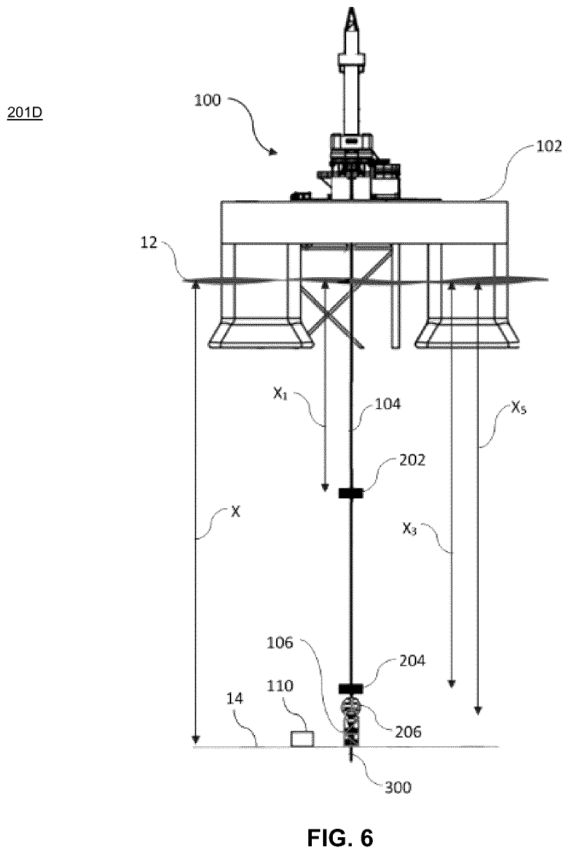

FIG. 6 shows another example of a system 201D that includes many of the same features as system 201B, system 201C and optionally system 201D with the at least one tool comprising both the second tool 202 that is operatively coupled to the marine riser 104 and the third tool 204 that is operatively coupled to the marine riser 104 proximal to the subsea wellhead 106. Optionally, the at least one tool may also comprise the fourth tool 206 that is operatively coupled to the riser 104 and the subsea wellhead 106.

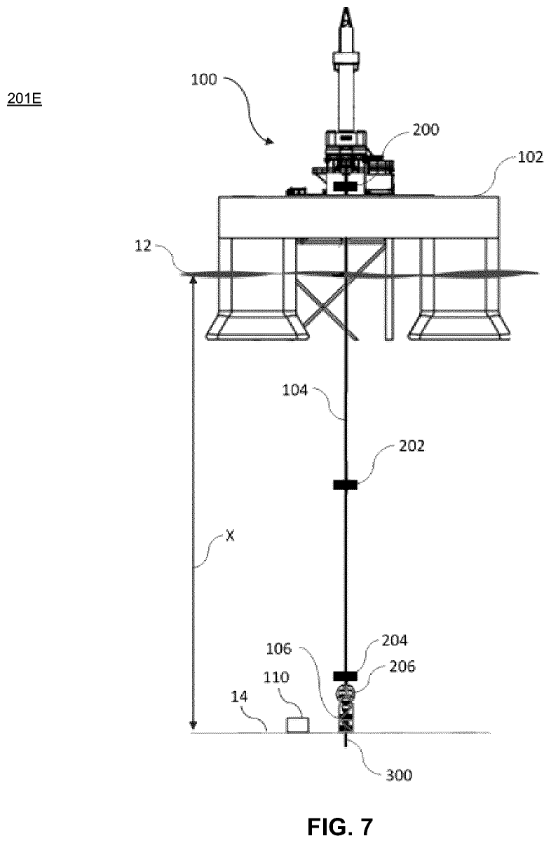

FIG. 7 shows another example of a system 201E that includes many of the same features as systems 201, 201A, 201B and 201C (optionally system 201D) with the at least one tool comprising the first tool 200, the second tool 202, the third tool 204 and, optionally, the fourth tool 206.

In some embodiments of the present disclosure, the system 201E can comprise the components of two or more of systems 201, 201A, 201B, 201C and 201D.

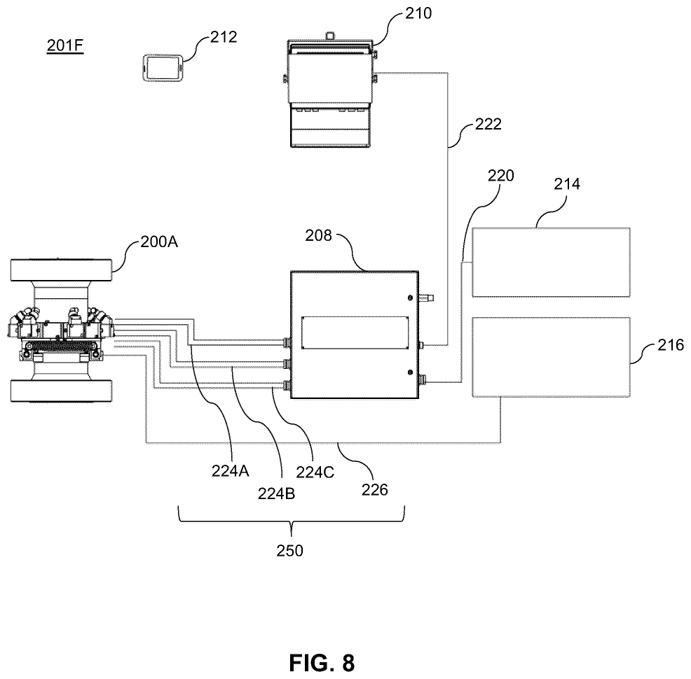

FIG. 8 is a schematic of a portion of any one of systems 201A, 201B, 201C, 201D, 201E (collectively shown as 201F). A tool 200A is shown to represent any one of the first tool 200, the second tool 202, the third tool 204 or the fourth tool 206. The tool 200A is operatively connected to a processor unit 208 by a first conduit 250. When the tool 200A comprises a tool array 290 (as discussed further herein below), the tool array 290 can comprise one or more magnetic sensors 260. Each magnetic sensor 260 can be individually operatively connected to the processor unit 208 by an individual conduit 224A, 224B or 224C. For example, when there are three individual magnetic sensors 260, each of which can send a perturbation signal—or any other type of signal—to the processor unit 208. The processor unit 208 is operatively connected to a sub-processor unit 210 by a conduit 222 or optionally the processor unit 208 may alternatively or additionally be operatively connected to the sub-processor unit 210 wirelessly. In some examples, this wireless connection can be established by one or more of various protocols including but not limited to: IEEE 802.11x protocol, BlueTooth, radio signal transmission and receipt, cellular connections, satellite connection or other known approaches for wirelessly sending and receiving messages. A power supply 214 can be operatively connected to the processor unit 208 to supply power thereto by a conduit 220. The processor unit 208 can also supply power to the tool array 290 by the first conduit 250. In some embodiments of the present disclosure, the power supply 214 can be a 115 VAC, 1100 W power supply. Optionally, a power supply 216, which can be pneumatic, electronic or hydraulic, can also be operatively connected to the tool array 290 by a conduit 226. The conduit 226 can also form part of the first conduit 250.

The processor unit 208 can house a processor that is configured to receive the perturbation signal from the tool array 290 and for generating a processor output signal that is communicated to the sub-processor unit 210. In some embodiments of the present disclosure, the sub-processor unit 210 may comprise a display unit or a human machine interface that is capable of displaying a graphical representation and/or numeric representation or textual representation of the signals received and sent to and from the processor unit 208. In some embodiments of the present disclosure the sub-processor unit 208 may also comprise input capabilities so that commands can be entered into the sub-processor unit 208 and then communicated to the processor unit 208. The processor may be any one of commonly available personal computers or workstations having a processor, a microprocessor, a field programmable gate array, programmable logic controller or combinations thereof that include a volatile and non-volatile memory, and an interface circuit for interconnection to one or more peripheral devices for data input and output. In some embodiments of the present disclosure, the processor may include processor-executable instructions, in the form of application software, that may be loaded into the memory that allow the processor to adapt its processor to receive, store and query various input signals. In some embodiments of the present disclosure, the processor can also send one or more instructions or commands to other components of the tool array 290 or the sub-processor unit 210. For example, the processor can send a display signal to the sub-processor unit 210 that visually displays the perturbation signal by one or more magnetic sensors 260. The signal output represents the detected parameters of the magnetic field and any perturbations thereto.

As shown in FIG. 8, the system 201F may further comprise one or more user input and display devices 212 that are remotely connected to the sub-processor unit 210 and/or directly to the processor unit 208. A user can receive a display signal on the input and display devices 212 and the user can send commands to the tool array 290 by the sub-processor unit 210 and/or the processor unit 208.

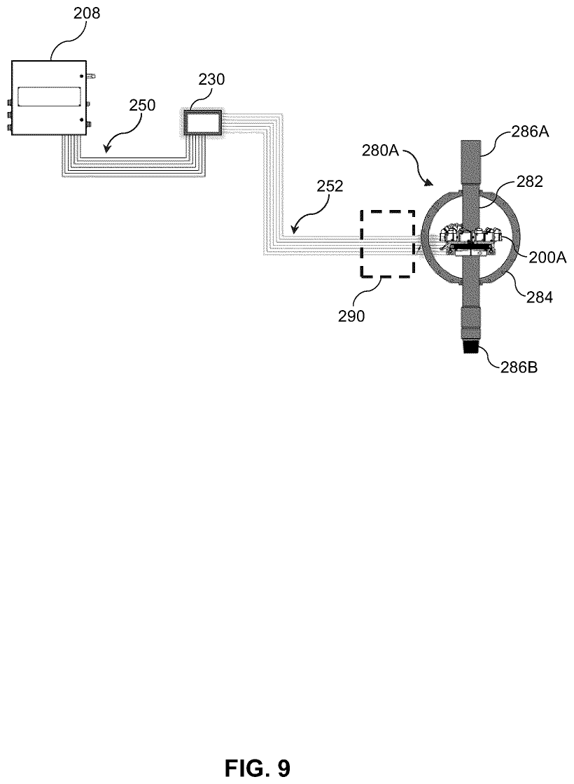

FIG. 9 shows another example of the system 201F that further comprises an optional interface box 230 that is operatively coupled to the first conduit 250 and that is operatively connected to the tool 200A by a second conduit 252, which may also be referred to as a subsea umbilical assembly. The interface box 230 provides an operative connection to the second conduit 252. In some embodiments of the present disclosure, interface box 230 may be located on the offshore vessel 100 and the first conduit 250 and the second conduit 250 are constructed of suitable materials to provide protection from the corrosive water, turbidity, temperatures, potential collisions with marine objects, plants or animals, and hydrostatic pressures of the subsea environment. In some embodiments, only the second conduit 252 is protected from the subsea environment by being constructed of suitable materials. The interface box 230 may be configured to provide an operative connection between different types of electrical components such as subsea electrical components and dry electrical components. Optionally, the second conduit 252 may comprise a converter 290. In some embodiments of the present disclosure, the converter 290 is an analogue to digital converter that converts data at a rate of between about 10 Kbits/second to about 24 Mbit/second. The converter 290 may also comprise multiple 250 KHz channels with a resolution of about 16 bits that operates on an Ethernet protocol. Optionally, the converter 290 is a controller such as a field programmable gate array (FPGA), a programmable logic controller (PLC) or other types of known controllers. In some embodiments of the present disclosure, the second conduit 252 can includes a power and signal/data communication conduit for communicating between the subsea environment and the surface, or a separate conduit for power and a separate conduit for data/signal communication.

FIG. 9 also shows a subsea housing unit 284 that is configured to protect the tool 200A from the subsea environment. The subsea housing unit 284 may provide protection against hydrostatic pressures associated with positioning the tool 200A between about 50 feet and about 20,000 feet below the surface 12. The subsea housing unit 284 can also protect the tool 200A from the corrosive or electrical-short potential of the surrounding water. In some embodiments of the present disclosure, the subsea housing unit 284 is constructed of non-magnetic materials. In some embodiments of the present disclosure, the subsea housing unit 284 is partially filled with or substantially completely filled with a dielectric material.

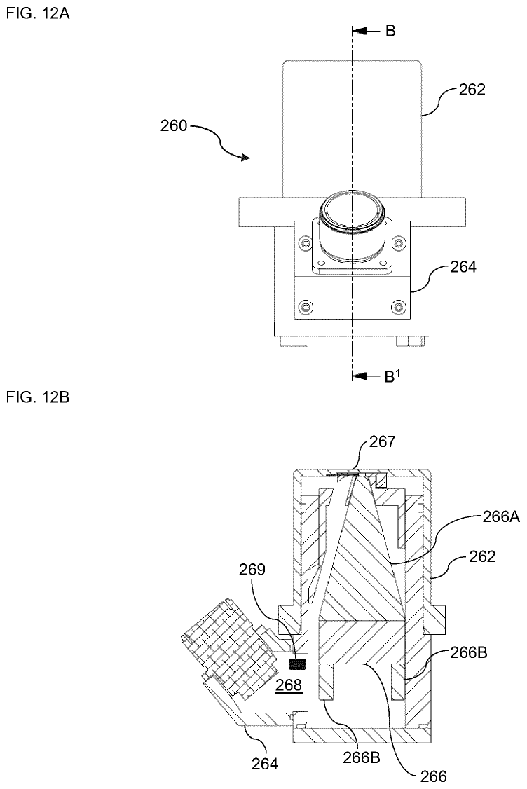

FIG. 10A and FIG. 10B show the tool 200A, the tool array 292 may comprises one or more magnetic sensors 260 that each comprise a magnetic-magnetic-sensing element 267 and, optionally, a magnetic-affecting element 266A (see FIG. 12). The magnetic sensor 260 can be used in any application where it is desired to detect one or more properties of a magnetic field that is proximal to the magnetic sensor 260 and to detect changes in those properties. For example, the magnetic sensor 260 can be used to detect the magnetic flux of a magnetic field and to detect changes in the magnetic flux of that magnetic field (as discussed further below).

As will be appreciated by one skilled in the art, the tool array 290 can move between a closed position (FIG. 10A) and an open position (FIG. 10B). An actuator 292 can receive a command to move the tool array 290 between these two positions. In some embodiments of the present disclosure, the actuator 292 can be powered by the power supply 216.

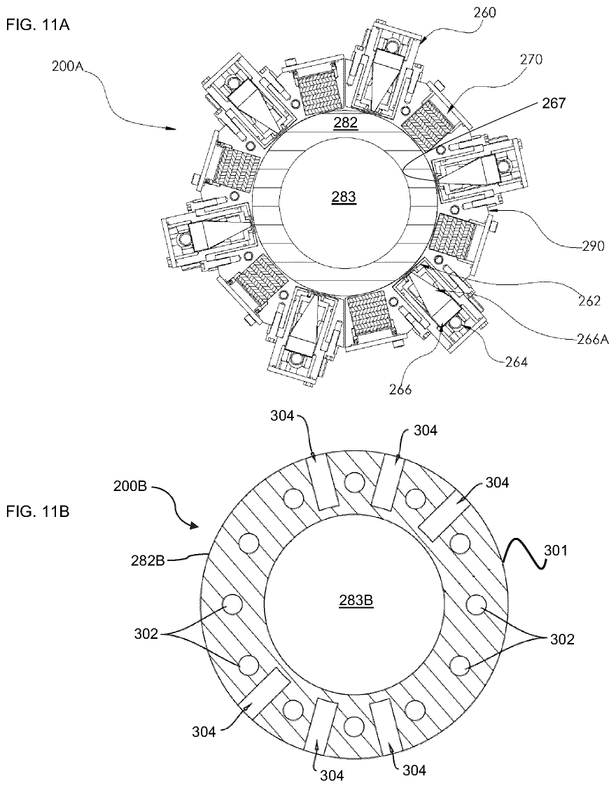

FIG. 11A shows a cross-sectional view of one embodiment of the tool 200A that is taken in the same plane as the horizontal centerline of the tool array 290.

In this embodiment of the tool 200A, the tool array 290 comprises the tubular portion 292, one or more magnetic sensors 260 and one or more of an optional source of the magnetic field 270. The tool 200A comprises the tubular portion 282 that defines a central bore 283. Operatively coupled about the outer surface of the tubular portion 282 is the tool array 290 that comprises one or more magnetic sensors 260 and one or more sources of the magnetic field 270. The one or more sources of the magnetic field 270 may be rare earth magnets, electromagnets or combinations thereof. As shown in the non-limiting embodiment of FIG. 11, the magnetic sensors 260 and the source of the magnetic field 270 may be spaced about the tubular portion 282 in an alternating and substantially even pattern. Other embodiments of the present disclosure contemplate other patterns within the tool array 290, some of which include one or more sources of a magnetic field 270 and some of which don't.

FIG. 11B shows another embodiment of a tool 200B that comprises a toms-shaped body 301, which may also be referred to herein as a tubular portion, that defines an internal bore 283B. The body 301 can be connected with other components of the systems 201A, B, C, D, E described herein, so that the central bore 283B is aligned in the same fashion as the central bore 283 of the tool 200A. The body 301 can be connected by inserting connectors (not shown) to the lubricator 105 or the riser 104 or other relevant portion of the subsea wellhead 106 through one or more connector bores 302. The body 301 also defines one or more bores 304 that extend from an outer, lateral surface of the body 301 towards the central bore 283B. The bores 304 may communicate with the central bore 283B or not. The one or more bores 304 are configured to receive and house one of a magnetic sensor 260 or a source of magnetic field 270. In some embodiments of the present disclosure, the tool 200B is similar to the apparatus described in U.S. Pat. Nos. 9,097,813 or 9,909,411, the description of each are incorporated herein by reference.

As shown in FIG. 12, in some embodiments of the present disclosure, magnetic-affecting element 266A can have a frustoconcial shape or the magnetic-affecting element 266A can have another shape, for example a cylindrical shape. In some embodiments of the present disclosure, the magnetic-sensing element 267 is configured to detect one or more properties of a magnetic field. In some embodiments of the present disclosure, the magnetic-sensing element 267 is configured to detect changes in one or more properties of a magnetic field over time. For example, the magnetic-sensing element 267 can detect perturbations, which are also referred to as fluctuations or changes, in one or more properties of the magnetic field. The magnetic-sensing element 267 can be one or more of the following types of sensing elements, such as a Hall Effect sensor, a microelectromechanical systems (MEMS) magnetic field sensor, a magneto-diode, a magneto-transistor, an anisotropic magnetoresistance magnetometer, a giant magnetoresistance magnetometer, a magnetic tunnel junction magnetometer, a magneto-optical sensor, a Lorentz force based MEMS sensor, an electron tunneling based MEMS sensor, a MEMS compass, an optically pumped, magnetic field sensor, a fluxgate magnetometer, and a superconducting quantum interference magnetometer device.

The magnetic-sensing element 267 is also configured to detect and report the detected perturbation in one or more properties of the magnetic field by generating a perturbation signal. The output signal can be optical, digital, analogue or some other form of signal is transmitted (wired or wirelessly) to the processor unit 208 (see FIG. 8 and FIG. 9). The perturbation signal corresponds to the magnitude or direction of the detected perturbation in the magnetic field. For example, the output signal may be an output voltage. A given voltage of the output signal may reflect the amplitude of a given property of the magnetic field, for example the magnitude of the flux density of the magnetic field at a given position. No change in the output signal which could indicate a substantially constant property of magnetic field that the magnetic-sensing element 267 is configured to detect over the relevant time-period. A change in the output voltage reflects a change in the detected property that may be due to either a perturbation in the magnetic field source or a perturbation in the environment that the magnetic field passes through and that is detectable by the sensor. For example, if the perturbation indicates a reduction in the magnetic field, this may mean that the magnetic field source has reduced its output strength or it may indicate that the magnetic field source has changed its direction or position relative to the sensor. Alternatively, the perturbation may be a result of a ferromagnetic object that is proximal to or within the magnetic field has changed its position.

In some embodiments of the present disclosure the magnetic-sensing element 267 is configured to measure the magnetic flux and/or the magnetic flux density that is present in the same physical area as, or proximal to, the magnetic-sensing element 267. The magnetic-sensing element 267 may also be configured to detect the direction of the magnetic field, either in addition to the magnetic flux and/or the magnetic flux density, or not.

In some embodiments of the present disclosure the magnetic-affecting element 266A has a first end and a second end. The first end is configured to connect to a mount for mounting the magnetic sensor 260 within or upon a housing that, in some non-limiting embodiments of the present disclosure, may be made up of a first housing component 262 and a second housing component 264. The magnetic-sensing element 267 can be coupled to the magnetic-affecting element 266A proximal the second end. In some embodiments of the present disclosure, the magnetic-affecting element 266A is made of a ferromagnetic material or ferrimagnetic material. Examples of ferromagnetic materials include, but not limited to: iron, nickel, cobalt, an iron alloy, a nickel alloy, a cobalt alloy, iron-based materials, nickel-based material, cobalt-based materials, or combinations thereof. It is understood that the magnetic-affecting element 266A may take different shapes. For example, the magnetic-affecting element 266A can be frustoconical with different cross-sectional diameter at each end, cylindrical with a substantially constant cross-sectional diameter or it can take any other polygonal shape when viewed in cross-section. In some embodiments of the present disclosure it may be preferred that the magnetic-affecting element 266A has a shape where the second end is approximately the same or substantially the same cross-sectional size as the magnetic-sensing element 267.

The ferromagnetic materials of the magnetic-affecting element 266A, 14C can attract at least a portion of the magnetic field toward the magnetic-affecting element 266A, which in turn may attract substantially the same portion or a part of the same portion of the magnetic field towards and/or through the magnetic-sensing element 267. Without being bound by any particular theory, the magnetic-affecting element's 266A attraction of the portion magnetic field focuses the magnetic field towards and/or through the magnetic-sensing element 267 and that focus may provide an increased sensitivity and/or resolution of the magnetic sensor 260. In particular, the shape of the magnetic-affecting element 266A may provide an increased focus of the target magnetic-field through the magnetic-sensing element. An increased sensitivity of the magnetic sensor 260 allows for detecting and reporting smaller absolute levels of the detected properties of the magnetic field. An increased resolution allows the magnetic sensor 260 to detect and report smaller relative changes of the detected properties of the target magnetic-field.

In some embodiments of the present disclosure, the magnetic-affecting element 266A, may allow the magnetic sensor 260 to detect smaller perturbations of the properties of the magnetic field than the magnetic-sensing element 267 would be able to detect without the magnetic-affecting element 266A. For example, if a ferromagnetic body approaches, is moving through and/or moving away from the magnetic field that will perturb the magnetic field in various ways. The perturbations of the magnetic field will be evidenced by detected changes in one or more properties of the magnetic field at the position where the sensor 260 is located. That perturbation of the magnetic field will allow the magnetic-sensing element 267 to generate an output signal that will report the perturbation of the magnetic field caused by the ferromagnetic body. In some applications, reporting a perturbation of the magnetic field is useful to know when a ferromagnetic body is approaching, moving through and/or moving away from the magnetic field. Furthermore, the perturbation of the magnetic field can also indicate when a different portion of the object that is approaching, moving though and/or moving away from the magnetic field and that different portion has a different physical dimension than other portions of the object, those different dimensions can be detected. Furthermore, perturbations in the magnetic field can also be used to determine the position of the object within a central bore of the tubular portion 282. This positional information may be used to determine if the object is centralized within the tubular portion 282.

In some embodiments of the present disclosure the magnetic sensor 260 may include a secondary magnet 266 that is positioned at or proximal to the first end or the second end of the magnetic-affecting element 266A. The secondary magnet 266 may be oriented so that the magnetic field direction of the secondary magnet 266 may attract or repel more of the target magnetic-field. In some embodiments of the present disclosure, the secondary magnet 266 is oriented to repel at least a portion of the target magnetic-field away from the magnetic-magnetic-sensing element 267. In other embodiments of the present disclosure the secondary magnet 266 is oriented to attract at least a further portion of the target magnetic-field towards and through the magnetic-magnetic-sensing element 267 than is otherwise attracted towards and through the magnetic-magnetic-sensing element 267. For example, the secondary magnet 266 may increase the density of the target magnetic-field that is passing through the magnetic-magnetic-sensing element 267, which may in turn increase the overall sensitivity of the magnetic sensor 260.

In some embodiments of the present disclosure, the magnetic sensor 260 may further comprise a housing made up of components 262, 264 that are configured to fit together to house and protect the internal components of the magnetic sensor 260.

For example, the housing components 262, 264 may define an internal plenum 268 in which the magnetic-sensing element 267, the magnetic-affecting element 266A, the secondary magnetic 266 are positioned with the assistance of one or more spacer units 266B. In some embodiments of the present disclosure, the internal plenum 268 may be at least partially filled with a potting agent 269. The potting agent 269 may be selected based upon its physical properties. For example, the potting agent 269 may be a fluid in a first phase when it is introduced into the internal plenum 218 and then harden into a more solid second phase that is positioned about the internal components of the magnetic sensor 260. While FIG. 12B only shows a single dot to represent the potting agent 269, the skilled person will appreciate that some, substantially all or all of the unoccupied space within the plenum 268 can be filled with the potting agent 269. The potting agent 269 may be stable or predictably expandable within the temperature span that the magnetic sensor 260 is going to be used in. The potting agent 269 may also be dielectric so that it doesn't interfere with the various electrical connections within the magnetic sensor 260. When in the second phase, the potting agent 269 may be hard enough to improve the mechanical stability of the internal components of the magnetic sensor 260 from any vibration or impact. The potting agent 269 also should not otherwise interfere with the magnetic-field detection functionality of the magnetic sensor 260 as described herein. Some non-limiting examples of suitable potting agents 269 include epoxy, silicone, urethane or combinations thereof.

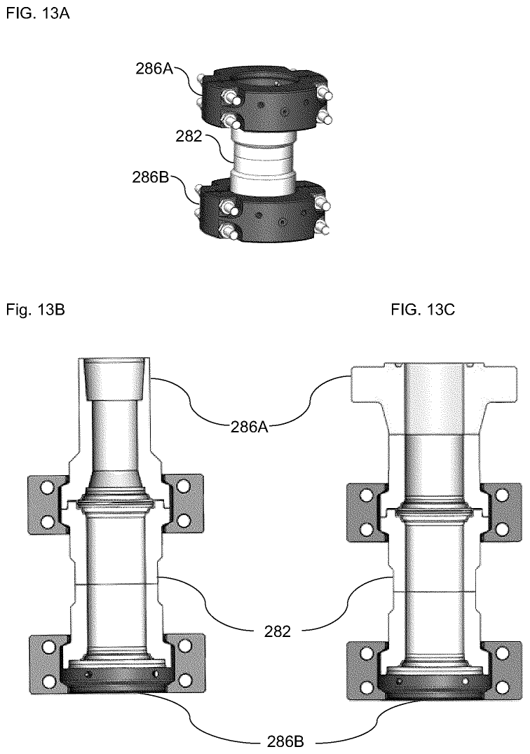

FIG. 13 shows some further embodiments of the present disclosure that relate to the tubular portion 282 and the connection members 286A, 286B. In some embodiments of the present disclosure, the tubular portion 282 is constructed of the same materials as the connection members 286A, 286B and in other embodiments of the present disclosure the tubular portion 282 and the connection members 286A, 286B are constructed of different materials. In some embodiments of the present disclosure, the tubular portion 282 is constructed of a non-magnetic material such as, but not limited to: 316 stainless steel, 360 stainless steel, nitronic 50 stainless, 625 Inconel, 718 Inconel, aluminum, one or more polymers, plastic or combinations thereof. More generally, a non-magnetic material is one that does not interact with or otherwise alter one or more properties of the magnetic field when positioned within or proximal to the magnetic field. In some embodiments of the present disclosure, a non-magnetic material is paramagnetic or diamagnetic with a relative magnetic permeability of about 1.00+/−0.01. In some embodiments of the present disclosure, when the tool 200A is housed within the subsea housing unit 284, the tool 200A may have a band of non-magnetic material that is positioned between about 1 and about 15 inches of non-magnetic material above and below the horizontal centerline of the tool array 290. In some embodiments of the present disclosure there is between about 2 and about 12 inches of non-magnetic material above and below the horizontal centerline of the tool array 290. In some embodiments of the present disclosure, there is a minimum of between about 4 and about 6 inches of non-magnetic material above and below the horizontal centerline of the tool array 290. In some embodiments of the present disclosure, beyond the band of non-magnetic material the tool 200A may comprise a mass of magnetic material. Some examples of magnetic materials including, but are not limited to: carbon steel, 4130 low alloy steel, nickel, iron, another elementary material and combinations thereof. More generally, a magnetic material is a material that will perturb one or more properties of a magnetic field when positioned within or proximal thereto. In some embodiments, the mass of magnetic material can be configured for operatively coupling the tool 200A to the subsea housing 284.

In some embodiments of the present disclosure, the tubular portion 282 may comprise different portions that are made up of different materials, such as magnetic and non-magnetic materials. These different portions can be connected to each other by threaded connections, bolted connections, welding or combinations thereof.

FIG. 13A shows one embodiment of the tool 200A, where the connection members 286A and 286B are boltable clamps for connecting to the riser 104 and/or the subsea wellhead 106. The connection members 286A and 286B can be constructed of magnetic or non-magnetic materials.

FIG. 13B shows another embodiment of the tool 200A, where the connection members 286A and 286B are threaded for connecting to the riser 104 and/or the subsea wellhead 106. The connection members 286A and 286B can be constructed of magnetic or non-magnetic materials.

FIG. 13C shows another embodiment of the tool 200A, where the connection members 286A and 286B are flanged connections, hubs, Bowen unions or combinations thereof for connecting to the riser 104 and/or the subsea wellhead 106. The connection members 286A and 286B can be constructed of magnetic or non-magnetic materials.

As described herein above, the tool 200A can also be used to determine when an object that is passing through the central bore 283 of the tubular portion 282 at a position that is off centered. In some embodiments of the present disclosure, the processor divides the central bore 283 into four quadrants—when view from a top plan view. Based upon the perturbation signals sent from one or more magnetic sensors 260, the processor can calculate the distance of the object from the center of the four quadrants by assessing the lateral position of the object relative to the center of the central bore 283. If the processor determines that the object is positioned too far from the center of the central bore 283 (i.e. beyond the normal fluctuations in position that occur while tubing is moved through the system) then the processor can generate a center deviation alarm. The center deviation alarm may be indicative of the offshore vessel 100 being in a position that alters the path that the tubing is moving along within the riser 104 and/or the alignment of the riser 104 relative to the subsea wellhead 106. Such an altered path of tubing movement can result in degradation of the internal surface of the riser 104 and/or the outer surface of the tubing and it may also result in putting the rise 104, or other components, under a dangerous bending load, which can result in catastrophic failure.

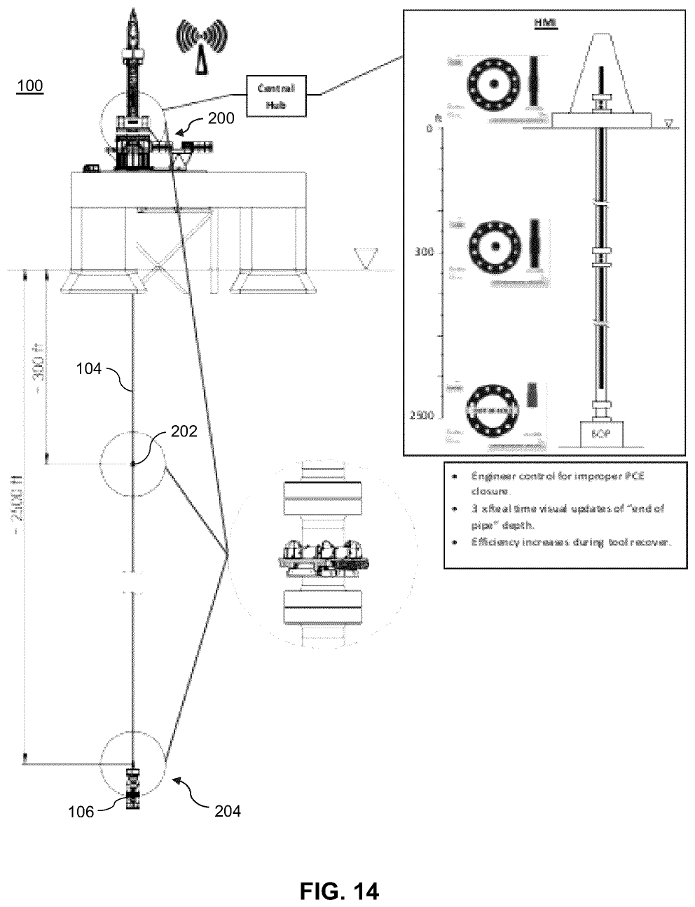

FIG. 14 is schematic representation of a method of using the systems described herein. The system includes the first tool 200, the second tool 202 and either or both of the third tool 204 and the fourth tool 206. Within the riser 104 is a tubing string that is being pulled up out of the subsea well 300 and into the off shore vessel 100. As the tubing string leaves the subsea wellhead 106, the third (or fourth) tool 204 (206) will determine when the bottom of the tubing string has passed and cleared out of the subsea wellhead 106. As the pulling of the tubing string continues, the second tool 202 will then provide a signal that the bottom of the tubing string has cleared its position. This information may be useful to operators to know that they can move the tubing string at a faster rate when the end of the tubing string is not close to any lubricators or pressure control mechanisms. The methods of the present disclosure may also be utilized when a tool is attached to the bottom of the tubing string, to allow the operators to know when the larger outer diameter tool has cleared certain portions of its travel from the subsea well 300 to the offshore vessel 100. The methods of the present disclosure may also be utilized to assess when it is safe to close or open subsea pressure control valves.

As will be appreciated by one skilled in the art, the embodiments of the present disclosure relate to detecting the presence, position and dimensions of objects as they approach, pass through and move away from the tools described herein. By detecting the presence of an object, the operators will have knowledge about the location of various parts of a drill string, tubing string, coiled tubing, wireline and any objects located thereon. Additionally, the operator may acquire knowledge about where a lost tool may be located. By detecting the position of an object as it approaches, passes through and moves away from the tools described herein, the operator may acquire knowledge about a chance in the position of the offshore vessel that could detrimentally impact the system and or whether or not a portion of the object is crimped, crumpled or otherwise deformed. By acquiring knowledge about the dimensions of the object as it approaches, passes through and moves away from the tools described herein, the operator may be able to determine which parts of the object are safely shearable because they are not a crimped, crumpled or otherwise a deformed portion of the object and/or the parts of the object are not a part of any that would not be shearable and/or the parts are not couplers or other parts of the object that are otherwise not shearable.

1. A system comprising:
(a) a processor unit; and
(b) at least one tool that is connectible to a lubricator on an offshore vessel and/or a subsea riser and/or a subsea wellhead, the at least one tool is operatively communicatable with the processor unit, wherein the at least one tool is configured to detect a perturbation in a magnetic field that is proximal the at least one tool and to generate a perturbation signal that is communicatable to the processor unit.

2. The system of claim 1, wherein the at least one tool is configured to generate a magnetic field that extends at least partially through a central bore of the lubricator and/or a central bore of the subsea riser and/or a central bore of the subsea wellhead.

3. The system of claim 1, wherein the processor unit is positioned on an offshore vessel.

4. The system of claim 1, wherein the processor unit is positioned subsea.

5. The system of claim 2, wherein the processor unit comprises a processor that is configured to generate a command for the at least one tool to generate the magnetic field and wherein this command is receivable by the at least one tool and wherein the at least one tool is configured to generate the magnetic field upon receipt of said comment from the processor.

6. The system of claim 5, wherein the processor is configured to receive the perturbation signal and to generate a visual display signal that is representative of the detected perturbation.

7. The system of claim 1, further comprising an input and display device that is configured to allow a user to input a command that the processor sends to the at least one tool and wherein the input and display device is configured to receive and display a visual display signal that is representative of the perturbation signal.

8. The system of claim 7, wherein the input and display device is coupled to the processor unit or it is remote from the processor unit.

9. The system of claim 1, wherein the at least one tool comprises a tubular portion and a tool array, wherein the at least one tubular portion defines a central bore between a first and second connection member at each end, wherein the first and second connection members are connectible to be aligned with the lubricator on the offshore vessel and/or the subsea riser and/or the subsea wellhead and wherein the tool array is configured to detect the perturbation in the magnetic field and to generate the perturbation signal.

10. The system of claim 9, wherein the tool array is positioned about the tubular portion.

11. The system of claim 9, wherein the tubular portion is constructed of a non-magnetic material.

12. The system of claim 11, wherein the non-magnetic material is a 316 stainless steel, a 360 stainless steel, nitronic 50 stainless steel, a 625 Inconel, a 718 Inconel, aluminum, one or more polymers, a plastic and combinations thereof.

13. The system of claim 9, wherein the tool array is configured to generate the magnetic field.

14. The system of claim 1, wherein the at least one tool is a first tool that is connectible to the lubricator that is positioned on the offshore vessel.

15. The system of claim 1, wherein the at least one tool comprises a second tool that is connectible to the subsea riser and wherein the system further comprises a subsea housing that is configured to house and protect the second tool from a subsea environment.

16. The system of claim 13, wherein the at least one tool comprises a third tool that is connectible to the subsea wellhead and wherein the system further comprises a subsea housing that is configured to house and protect the third tool from a subsea environment.

17. The system of claim 16, wherein the third tool is connectible to the subsea wellhead above, within or below a subsea blowout preventer stack of the subsea wellhead.

18. The system of claim 14, wherein the at least one tool comprises a second tool that is connectible to the subsea riser and wherein the system further comprises a subsea housing that is configured to house and protect the second tool from one or more properties of a subsea environment.

19. The system of claim 14, wherein the at least one tool further comprises a third tool that is connectible to the subsea wellhead and wherein the system further comprises a further subsea housing that is configured to house and protect the third tool from a subsea environment.

20. The system of any one of claim 15, wherein the subsea housing is constructed of a material that does not perturb the magnetic field.

21. The system of claim 1, wherein the at least one tool comprises a magnetic sensor that comprises a magnetic-sensing element that is configured to detect perturbations in the magnetic-field and a magnetic-affecting element that is configured to attract at least a portion of the magnetic field towards the magnetic-sensing element.

22. The system of claim 1, wherein the perturbation in the magnetic field is caused by introducing a body into or removing the body from within or proximal to the magnetic field, wherein the body is constructed of a material that can perturb the magnetic field.

23. The system of claim 1, wherein the perturbation in the magnetic field is caused by changing a position of the body within or proximal to the magnetic field.

24. The system of claim 1, wherein the perturbation in the magnetic field is caused by changing a physical dimension of a portion of the body that is within or proximal to the magnetic field.

25. The system of claim 1, wherein the at least one tool is further configured to generate a deviation-from-center signal and the at least one tool is configured to communicate the deviation-from-center signal to the processor and/or the input and display device.

26. The system of claim 1, wherein the at least one tool comprises a body that defines a central bore, wherein the body is alignable with the lubricator on the offshore vessel and/or the subsea riser and/or the subsea wellhead and wherein the body is further configured to receive and house a magnetic sensor that is configured to detect the perturbation in a magnetic field and to generate the perturbation signal.

27. A system comprising:
(a) a processor unit; and
(b) at least one tool that is connectible to a lubricator of a subsea wellhead, the at least one tool is operatively communicatable to the processor unit, wherein the at least one tool is configured to detect a perturbation in the magnetic field and to generate a perturbation signal that is communicatable to the processor unit.

28. The system of claim 27, wherein the at least one tool is further configured to generate a magnetic field that extends at least partially through a central bore of the lubricator.

29. A method of drilling or intervening on a subsea well, the method comprising steps of:
(a) connecting a riser between an offshore vessel and a blowout preventer stack of a subsea wellhead;
(b) generating a magnetic field above, within or below the blowout preventer stack;
(c) detecting a perturbation in the magnetic field; and
(d) communicating a perturbation in the magnetic field signal to a processor, wherein the perturbation in the magnetic field is caused by a body moving into, through or away from the magnetic field.

30. The method of claim 29, wherein the step of generating a magnetic field occurs above to the blowout preventer stack, distal to the blowout preventer stack and about the riser and the step of detecting occurs in substantially the same location.

31. The method of claim 29, wherein the step of generating a magnetic field occurs above and proximal to the blowout preventer stack and the step of detecting occurs in substantially the same location.

32. The method of claim 29, wherein the step of generating the magnetic field occurs within the blowout preventer stack and the step of detecting occurs in substantially the same location.

33. The method of claim 29, wherein the step of generating the magnetic field occurs below the blowout preventer stack and the step of detecting occurs in substantially the same location.

34. A method of intervening on a subsea well, the method comprising steps of:
(a) generating a magnetic field at a position between a subsea blowout preventer stack and a subsea lubricator connected thereto, wherein the subsea blowout preventer stack is operatively coupled to a subsea wellhead;
(b) detecting a perturbation in the magnetic field; and
(c) communicating a perturbation in the magnetic field signal to a processor, wherein the perturbation in the magnetic field is caused by a body moving into, through or away from the magnetic field as it moves between the blowout preventer stack and the subsea lubricator.
